(19) United States
(12) Patent Application Publication
(10) Pub. No.: US 2017/0004139 A1
(43) Pub. Date: Jan. 5, 2017

(54) SEARCHABLE ANNOTATIONS-AUGMENTED ON-LINE COURSE CONTENT

(71) Applicant: COURSERA, INC., Mountain View, CA (US)

(72) Inventors: Jonathan WONG, Mountain View, CA (US); Leith ABDULLA, Menlo Park, CA (US)

(21) Appl. No.: 14/788,490

(22) Filed: Jun. 30, 2015

(51) Int. Cl. G06F 17/30; G09B 5/02; G06F 3/0482; G06F 3/0484; H04L 29/06; G06F 17/24

(52) U.S. Cl. CPC G06F 17/3082; H04L 67/42; G06F 17/241; G06F 3/0482; G06F 3/0484; G09B 5/02; G06F 17/30864

(57) ABSTRACT

A method for augmenting or enhancing on-line course content includes displaying an on-line education course video to one or more viewers on network-connected viewing devices, receiving viewer annotations data including viewer annotations of video fragments, segments or frames of the displayed course video, and accumulating the viewer annotations data as annotation data records in in a searchable database. Each annotation data record includes annotation text for a respective video fragment, segment or frame of the displayed course video to which the annotation text applies. When a user query or search term has a match in the annotation text in an accumulated annotation data record, the method returns a search result based on information in the accumulated annotation data record including a link to the specific video fragment of course video to which the annotation text applies.

### BACKGROUND

With widespread implementation of advances in electronic communication technologies (such as network connectivity, the Internet, and on-line services including video streaming services), the use and transmission of videos as digital media is now commonplace.

Videos are becoming ubiquitous in the curricula of most academic disciplines. An on-line education course or class may, for example, include educational course content packaged as lecture videos, documentary or film videos, interactive instruction videos, etc. Viewing and learning from the on-line education course or class videos need not be a passive one-way affair for an on-line student or learner. Viewing and learning from the on-line education course or class videos can involve active instructor-student interactions simulating, for example, student questions and instructor answers in a traditional classroom or lecture hall environment. The students may electronically (or otherwise) submit questions or other feedback on the video. The instructor can then review the feedback on the video and reply to student questions, for example, with media rich notes, links to additional media resources and direct citations to resources in the libraries.

Consideration is now given to systems and methods for enhancing or augmenting on-line education course content. In particular, attention is directed to enhancing or augmenting on-line education course content based on feedback from multiple users.

### SUMMARY

In a general aspect, a system includes a server configured to provide a video to a client device for rendering on the client device. The system includes an annotations engine and a database (e.g., a searchable database). The annotations engine is configured to present a user interface on the computing device on which the video is rendered. The user interface includes one or more graphical user interface elements that are user-activable to annotate temporal frames, fragments or segments of the course video rendered on the computing device. One or more viewers may annotate the video. The database is configured to receive (e.g., from the annotations engine or other sources) form one or more viewers, and accumulate annotation data records related to the video in a searchable format. Each annotation data record includes a viewer annotation (textual or non-textual) of a frame, fragment or segment of the rendered video and a time definition of the annotated frame, fragment or segment of the video.

In example implementations of the database, the annotation data records in the database can be organized or indexed by time (e.g., time identifiers of a frame, fragment or segment), by annotation (e.g., original viewer annotation text or annotation icons), or by other keys (e.g., summary or extracts of processed original viewer annotation text, etc.).

In example implementations of the system, individual annotations received from viewers and their associated temporal identifier(s) can be further analyzed and processed (e.g., by an “analytics” server). The individual annotations received from viewers can, for example, be statistically analyzed to infer, for example, general user perceptions of portions of the video content. These user perceptions (e.g., “good” “interesting”, “difficult,” “beautiful”, “musical” etc.) can be used as keys to index the annotation data records in the database. Further, viewer entered annotations may be processed, for example, using statistical tools or natural language processing tools, to derive representative annotations or labels (e.g., frequently used phrases or words, synonyms, etc.) to use as keys to index the annotation data records in the database.

The annotations database records are stored in the database in a searchable format compatible with external query or search engines. A matching query or search term found in the annotations database records may direct a searcher to the specific temporal fragments, segments or frames of video annotated with the matching search term.

The details of one or more implementations are set forth in the accompanying drawings and the description below. Further features of the disclosed subject matter, its nature and various advantages will be more apparent from the accompanying drawings, the following detailed description, and the claims.

### BRIEF DESCRIPTION OF THE DRAWINGS

FIG. 1 is a schematic block diagram illustrating an example system for enhancing or augmenting on-line education course content, in accordance with the principles of the present disclosure.

FIG. 2 is a schematic illustration of a frontend user interface of an annotation engine or application, in accordance with the principles of the present disclosure.

FIG. 3 is a figure of a graphical display of a histogram of number of mentions of an annotation phrase associated with particular time slots of a video shown in comparison with a video rendering display area and time bar indicator associated with the video, in accordance with the principles of the present disclosure.

FIG. 4 is a flow chart illustrating elements of an example method for enhancing or augmenting on-line education course content and for utilizing the on-line education course content in different learning scenarios, in accordance with the principles of the present disclosure.

### DETAILED DESCRIPTION

Systems and methods for enhancing or augmenting on-line video content are described herein.

An on-line education course provider may present a course video to a student or learner over a network or Internet connection. The student or learner (or more generally “a viewer”) may view the course video, for example, in a video player on a network-connected viewing device or computing device. The viewer may use interactive features of the video player or the network-connected computing device to generate inline feedback on the course content during the course video presentation. The inline feedback may, for example, identify confusing or uninteresting parts of the course video, for example, as corresponding to parts when the viewer drops off from the course video presentation or to parts of the course video presentation which the viewer skips. Further, the video player or course video presentation may, for example, include graphical user interface elements (GUIs) (e.g., flags, check boxes, and buttons, etc.), which the viewer can activate to provide inline feedback (e.g., raise a GUI flag to indicate that “this part is confusing”). Additionally, a viewer may annotate the course video presentation using a video annotator tool to associate annotations (e.g., a comment, a note, an explanation, a question, a presentational markup, a link to another resource, or other text or typed information) with temporal fragments, segments or frames of the course video.

The video may have a total run or play time along a video timeline from a start time to an end time. As used herein, the term “time definition” of a temporal fragment, segment or frame of the course video may be understood to involve specifying a beginning time and an ending time of the temporal fragment, segment or frame of the course video relative to, for example, the start time of the course video. Further, the viewer annotations of the course video (including the associations of the annotations with specific temporal fragments, segments or frames of the course video) may be referred to herein as the course “video metadata.”

In accordance with the principles of the present disclosure, the systems and methods for enhancing or augmenting on-line video files with metadata, as described herein, may involve aggregating and storing the viewer annotations of the video (video metadata) in a video database. Viewer annotations of the video made by one or more viewers may be included in the video metadata stored in the video database.

In example implementations of the systems and methods, viewer annotations of the course video stored in the video database may be indexed by the corresponding specific temporal fragments, segments or frames of the course video to which the viewer annotations are applicable. Further, the viewer annotations of the course video may be stored in the video database in a searchable format, which may, for example, be compatible with external query or search engines (e.g., Internet search engines such as Google, Yahoo, etc.). A matching query or search term found in the video metadata may direct a searcher to relevant portions of the on-line education course related to the matching search term (i.e. the specific temporal fragments, segments or frames of the course video annotated with the matching search term). For example, in the context of an example on-line education course on water crafts, a matching search term “exercise” in the video metadata may direct the searcher to a specific video portion demonstrating or describing how to row a boat, which was previously annotated by a viewer with the text: “rowing a boat is a good exercise.” Such direction of the searcher to the specific video portion may make effective use or extend use of the on-line course content to learning scenarios and individuals beyond those which may have been contemplated or intended in the design of the on-line course presentation itself.

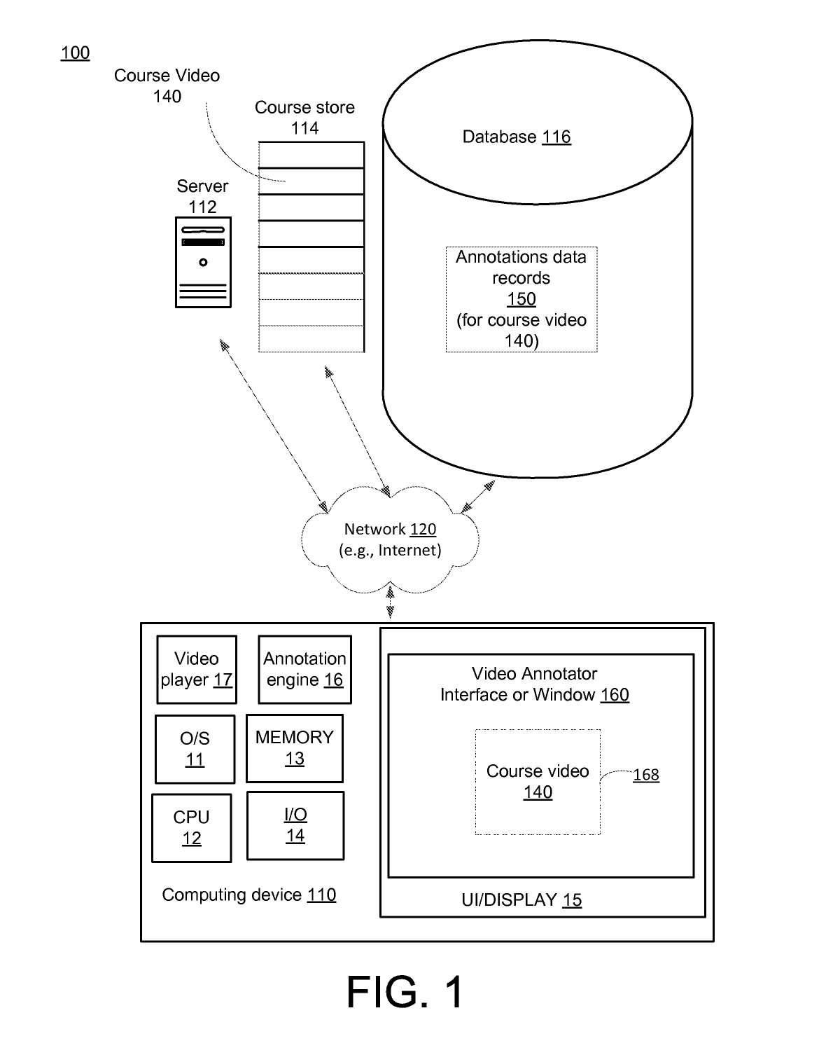

FIG. 1 schematically shows an example system 100 for enhancing or augmenting on-line education course content with viewer annotations, in accordance with the principles of the present disclosure.

System 100 may include a server 112, a course store 114, and a database 116. Server 112, course store 114, database 116 and other components of system 100 may be communicatively interlinked, for example, via a communications network 120 (e.g., the Internet). Course store 114 may include one or more user-selectable on-line education courses (e.g., course video 140) that a user can select for viewing. Server 112 may be configured to serve, for example, the user-selected on-line education course (e.g., course video 140) to one or more viewers on network viewing devices (e.g., computing device 110) for viewing.

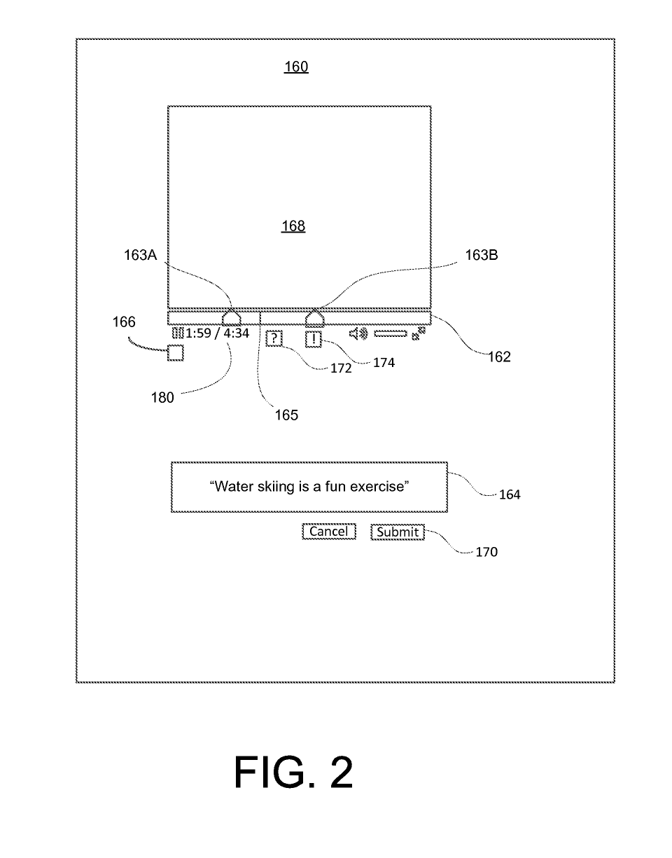

Computing device 110 may be a laptop computer, a desktop computer, a work station, a tablet, a smartphone, a server or other network viewing device. Computing device 110, which includes an O/S 11, a CPU 12, a memory 13, and I/O 14, may further include or be coupled to a user interface (UI) or display 15. In addition to having a capability (e.g., a video player 17) to run and display course video 140 in display 15, computing device 110 may host a video annotation application or engine (e.g., annotation engine 16) coupled to the display of course video 140 in display 15. Annotation engine 16 may cause a display of a graphical user interface (e.g., video annotator interface or window 160), which may include a video display area 168 in which video player 17 can run or display course video 140 in display 15. Further, annotation engine 16 and/or video annotator interface or window 160 may include user-activable graphical user interface elements that are configured to aid the viewer in annotating course video 140. FIG. 2 shows an example video annotator interface or window 160, which, in addition to video display area 168, includes one or more user-activable graphical user interface elements, for example, a visual sliding bar time indicator 162, along which beginning time marker 163A and ending time marker 163B can be slid, a text entry field 164, and a “pause video” checkbox or button 166, etc.

Sliding bar time indicator 162 may help the viewer visually identify and select specific temporal fragments, segments or frames of the displayed course video for annotation as the course video plays out. A left end of bar 162 can visually represent the beginning time of the video, the right end of the bar can visually represent the end time of the video, and a vertical line 165 can represent a current time of the video being played, relative to the beginning and ending times. A time stamp 180 can indicate the current time of the video that is being played and the full length (duration) of the video.

The viewer may annotate the specific temporal fragments, segments or frames of the course video of the displayed course video, for example, by writing or entering annotation text in text entry field 164. Pause video checkbox of button 166 may be a user-activable graphical user interface element that is configured to pause course video 140 while the viewer is writing or entering annotation text in text entry field 164. Sliding beginning and ending time markers 163A, 163B may be used by the viewer to visually identify or define the beginning time and the ending time of the specific temporal fragment, segment or frame of the course video that should be associated with the user-entered annotation text in text entry field 164. For example, the viewer may manually move the beginning and ending time markers 163A, 163B along the sliding bar time indicator 162 to demark the portion of the video with which the user intends to associate his/her annotation text. Each marker 163A, 163B may be associated with a particular frame of the video, and all of the frames between the frames associated with markers 163A, 163B can be associated with the annotation entered by the user. Once the user is satisfied with the text entered in text entry field 164 and with the positions of the beginning and ending time markers (163A, 163B) demarking the portion of the video with which to associate the entered text, the user can submit the text entry and the marked portion of the video (e.g., by clicking on a submit button 170) as metadata to server 112.

As shown for example in FIG. 2, in the context of the previously mentioned example on-line education course on water craft, the viewer may use video annotator interface or window 160 to enter the annotation text “water skiing is a fun exercise” in text entry field 164 and may identify the associated temporal fragment or segment of the course video by setting sliding beginning and ending time markers (163A and 163B), for example, at a beginning time of 1:00 minute and an ending time of 2:00 minutes, respectively.

In another implementation, the user may not set the beginning and ending time markers when entering and submitting annotation text, but rather may simply enter annotation text in the text entry field 164 and then submit the text (e.g., by clicking the submit button 170). The entered text can be associated with a frame of the video that was playing or being presented when the user first started entering text in the text entry field 164, or can be associated with a frame of the video that was playing or being presented when the user placed a cursor within the text entry field 164, or can be associated with a frame of the video that was playing or being presented when the user clicked the submit button 172 enter the annotation text. The entered text can be associated with all of the frames of the video that were presented while user composed the text entry field 164.

In some implementations, the viewer may be actively prompted to enter annotation text during the course of the playback of the video. For example, when the video concerns content of an on-line education course, the viewer may be prompted to enter comments, responses to questions, or other feedback during the course of the playback of the video. In some implementations, the video playback can be automatically paused until the user submits the feedback that is prompted and then restarted after receiving the prompted feedback.

In some implementations, a viewer can provide non-textual feedback on the video. For example, a user can select an icon 172 to indicate that the user to indicate that viewer finds a portion of the video content to be confusing. Icon 172 may, for example, be, a question mark, an image of a person scratching his head, a frowning face, etc. In another example, a user can select an icon 174 to indicate that the user finds a portion of the video to be particularly compelling. Icon 174 may, for example, be, an exclamation point, an image of a person smiling, a thumbs-up symbol, etc. In another example, the user can select others icons (not shown) to indicate that the user finds a portion of the video to be distasteful, sympathetic, beautiful, musical, etc.

It will be understood that in the foregoing description of system 100, annotation engine 16 has been described for convenience as being hosted on computing device 110. Annotation engine 16 may, for example, be pre-installed on computing device 110 or may be downloaded to computing device 110 (e.g., from server 112) before course video 140 is played. However, it will also be understood that in other example implementations of system 100, annotation engine 16 may be a backend application (e.g., a web application) residing or hosted on server 112 or elsewhere on network 120 in a server/client configuration. In such implementations, video annotator interface or window 160 may represent the front end user interface of backend application/annotation engine 16 on computing device 110.

System 100/annotation engine 16 may be configured to accumulate viewer annotations of course video 140 (“annotation data”) in searchable database 116, for example, as annotation data records 150. Each annotation data record 150 may include at least the annotation (textual or non-textual) entered by a viewer (e.g., “water skiing is a fun exercise”) and temporal identification of the video fragment or segment to which the annotation applies (e.g., video fragment: 1:00 minute-2:00 minutes). The temporal identification of the video fragment can be provided explicitly by the user (e.g., by the user setting beginning and ending markers 163) or can be determined implicitly (e.g., based on when the user enters or submits the annotation).

In some implementations, individual annotations received from users and their associated temporal identifier(s) can be analyzed statistically to infer general user perceptions of portions of the video content. For example, if 10,000 annotations are received on a video and 500 of the annotations mention the phrase “water skiing” in association with a temporal identifier between 1:00 minute from the beginning of the video and 2:00 minutes from the beginning of the video, and only 10 annotations mention the phrase “water skiing” in association with a temporal identifier outside of this range, then the time period between 1:00 minute from the beginning of the video and 2:00 minutes from the beginning of the video can be generally associated with the phrase “water skiing”. Additional statistical analysis techniques can be used to associate individual annotations with one or more particular parts of a video. For example, natural language processing can be applied to annotation text to determine related or synonymous annotations submitted by different users. Minimum thresholds of the number of individual mentions of a phrase can be set, which must be exceeded before the phrase is generally associated with a video or a particular time slice of the video.

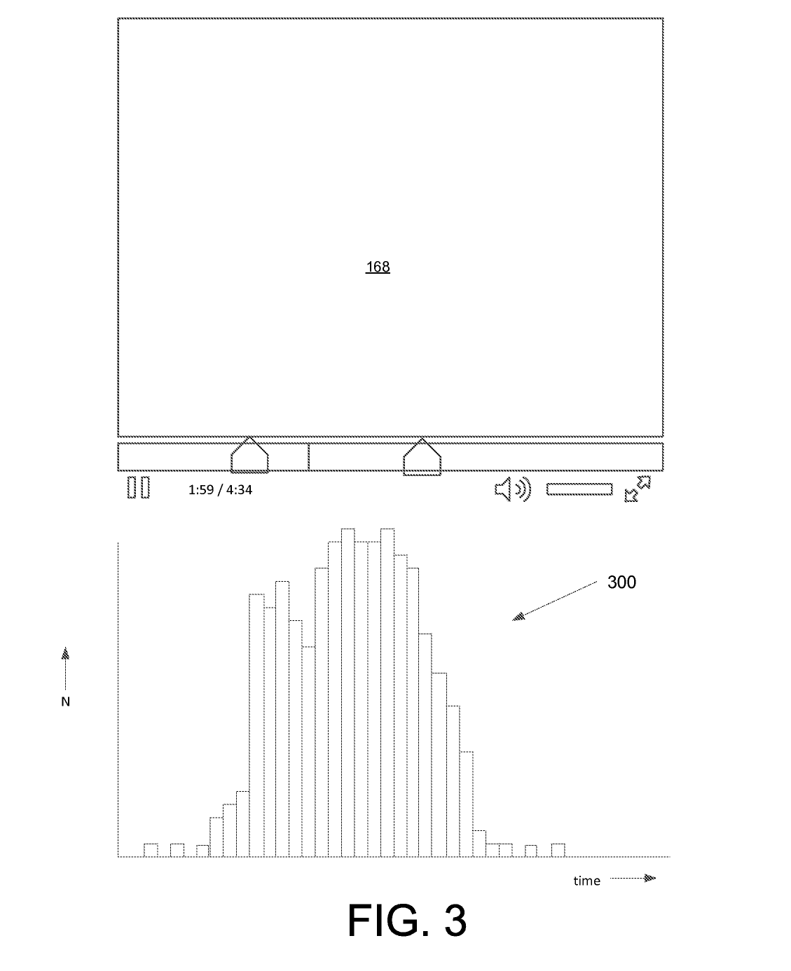

For example, FIG. 3 shows a histogram 300 of the number of individual mentions of an annotation phrase submitted during or associated with particular time slots of the video, shown in comparison with the video display area 168 and the visual sliding bar time indicator 162 of FIG. 2. From such statistical considerations as shown in FIG. 3, the annotation phrase can be statistically associated with particular frames of the video. For example, an annotation phrase may be generally associated with a video only if the annotation phrase is individually used a minimum number of times, or only used at least a minimum number of times within a time slot, or only if a rate of usage per unit time exceeds a threshold value. The start and end frames with which the annotation phrase is generally associated can be based on rate of usage per unit time exceeding a threshold value between the start and end frames, etc.

Once pluralities of annotations have been received in association with a video, the annotations can be used to search for and locate particular portions of the video. For example, portions of the video can be indexed by the phrases that are associated with the video, and text-based queries can be matched to the index to locate particular parts of the video. Similarly, non-text based annotations can be used to index videos, and then used to locate particular parts of the video. For example, non-text based annotations indicating portions of a video that are challenging or confusing can be used by an instructor of an on-line education course video to quickly locate portions of the video that may need revision.

In some implementations, a search engine may receive a query from a user who is seeking particular portions of one or more videos that match a query entered by the user. The received query may be matched against the index of annotations that are associated with one or more portions of one or more videos. In response to the query, search results can be provided to the user, where the search results include links to one or more videos including one or more segments that match the query. The search results can be ranked according to quality metrics that determine how closely the results match the query. The search results can include links to the particular time segments of the video that match the query, rather than to the start of the videos. The search results can be presented in a graphical user interface, and selection of an icon corresponding to one of the search results can cause the particular video segment of the search result to be played.

An annotation data record, which is accumulated in searchable database 116, may include a link to the video fragment or segment to which the annotation applies. For example, in the context of the previously mentioned example on-line education course on water craft, an annotation data record with the annotation text “water skiing is a fun exercise” may include a link to the specific video fragment (1:00 minute-2:00 minutes) of course video 140 to which the annotation applies. When a user query or search term directed to database 116 matches annotation text in the foregoing annotation data record, a search result returned from database 116 may include the link to the specific video fragment (1:00 minute-2:00 minutes) of course video 140 to which the annotation applies. The link may be utilized by a user as a convenient way of directly accessing the specific video fragment of course video 140 to which the annotation applies without having to acquire or run the entire course video 140.

With renewed reference to FIG. 1, in example web-based implementations of system 100, server 112 may be configured as a “content” web server to serve the user-selected on-line education course (e.g., course video 140) as web content to be viewed on computing device 110 via the internet (e.g. network 20). The viewer may use a web browser to access and download a “course” web page onto computing device 120. The web browser may render the web page so that the web page is viewable on display 15. Textual information may be displayed in a first portion of the web page and streaming video may be displayed in a second portion of the web page. In the example web-based implementations, video annotator interface or window 160 of annotation engine 16 may be integrated with or included in the web page viewable on display 15.

The example web-based implementations of system 100 may further include an “analytics” web server (not shown), which may be configured to track, analyze and report viewers interactions with the served web content. Such an analytics web server (or other server with similar functions) may also be used to track, analyze and report viewers' interactions with video annotator interface or window 160 of annotation engine 16.

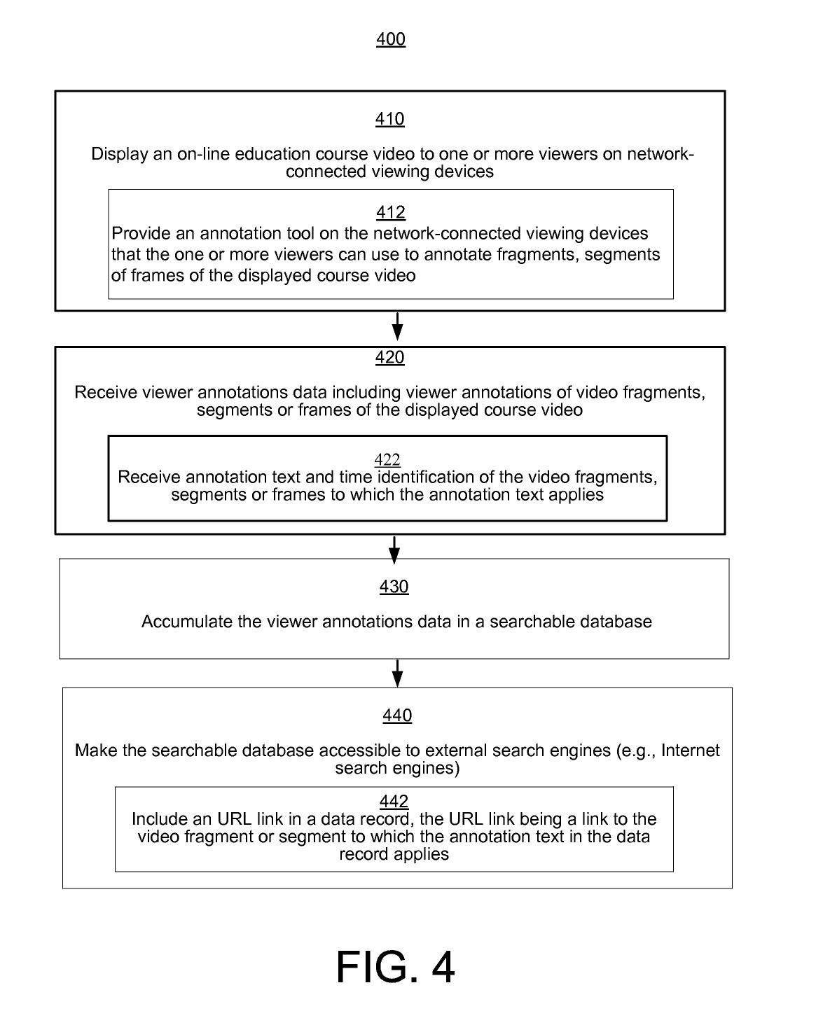

FIG. 4 is a flow chart illustrating elements of an example method 400 for enhancing or augmenting on-line education course content and for using the on-line education course content in different learning scenarios, in accordance with the principles of the present disclosure.

Method 400 may include displaying an on-line education course video to one or more viewers on network-connected viewing devices (410) and receiving viewer annotation data including viewer annotations of video fragments, segments or frames of the displayed course video (420).

Displaying an on-line education course video to one or more viewers on network-connected viewing devices 410 may be implemented in system 100, for example, by displaying course video 140 to a viewer on computing device 110. Further, displaying an on-line education course video to one or more viewers on network-connected viewing devices 410 may include providing an annotation tool on the network-connected viewing devices, which may be used by the one or more viewers to annotate fragments, segments of frames of the displayed course video (412).

In method 400, receiving viewer annotation data 420 may include receiving annotation text and time identification of the video fragments, segments or frames to which the annotation text applies (422).

Method 400 may further include accumulating the viewer annotation data in a searchable database (430). The viewer annotation data may be accumulated, for example, as annotation data records in the database. Each annotation data record may correspond to a respective viewer annotated video fragment, segment or frame of the course video. Each annotation data record may include at least the annotation text entered by a viewer (e.g., water skiing is a fun exercise) and temporal identification of the video fragment or segment to which the annotation applies (e.g., “video fragment: 1:00 minute-2:00 minutes”).

Method 400 may further include making the searchable database accessible to external search engines (e.g., Internet search engines) (440).

Further, in an example implementation of method 400, accumulating the viewer annotation data in the searchable database 430 may include including an URL link in an accumulated data record, the URL link being a link to the video fragment or segment (e.g., “video fragment: 1:00 minute-2:00 minutes”) to which the annotation text in the accumulated data record applies (442).

When a user query or search term matches annotation text in the accumulated data record, the database may return a search result based on information in the accumulated data record including the link to the specific video fragment (e.g., “video fragment: 1:00 minute-2:00 minutes”) of course video 140 to which the annotation applies.

The various techniques described herein may be implemented in digital electronic circuitry, or in computer hardware, firmware, software, or in combinations of them. The various techniques may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, logic circuitry or special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a server configured to provide a video to a client device for rendering on the client device; and
a database configured to receive and accumulate annotation data records, each annotation data record including a viewer annotation of a segment of the rendered video and a time definition of the segment of the video, wherein the annotation is associated with the time definition.

2. The system of claim 1, wherein the database is configured to receive and accumulate multiple annotation data records including viewer annotations of the video made by multiple viewers.

3. The system of claim 1, wherein the database is made accessible to external query or search engines.

4. The system of claim 1, wherein the viewer annotation of the segment of the course video presented on the computing device includes textual information.

5. The system of claim 1, wherein an accumulated annotation data record includes a link to the segment of the course video defined in the accumulated annotation data record.

6. The system of claim 5, wherein the database is configured to return the link to the segment of the course video defined in the accumulated annotation data record in a search result, when a user search query matches annotation text in the accumulated annotation data record.

7. The system of claim 1 further comprising an annotations engine configured to present a user interface on the computing device, the user interface including graphical user interface elements that are user-activable to annotate the segment of the course video presented on the computing device.

8. The system of claim 7 wherein the annotations engine is configured to send the annotation data record to the database for accumulation, the annotation data record including the viewer annotation of the segment of the course video presented on the computing device and the time definition of the segment of the course video.

9. The system of claim 7, wherein the annotations engine is hosted on the computing device.

10. The system of claim 7, wherein the annotations engine is a network-hosted application, the user interface on the computing device being a front end of the network-hosted application.

11. A method comprising:
displaying an on-line education course video to one or more viewers on network-connected viewing devices;
receiving viewer annotations data including viewer annotations of video fragments, segments or frames of the displayed course video; and
accumulating the viewer annotations data in a database.

12. The method of claim 11, wherein displaying an on-line education course video to one or more viewers on network-connected viewing devices includes providing an annotation tool on the network-connected viewing devices that the one or more viewers can use to annotate fragments, segments of frames of the displayed course video.

13. The method of claim 11, wherein receiving viewer annotations data including viewer annotations of video fragments, segments or frames of the displayed course video includes receiving annotation text and time identification of the video fragment, segment or frame to which the annotation text applies.

14. The method of claim 11, wherein accumulating the viewer annotations data in the database includes accumulating the viewer annotations data as annotation data records, each data record corresponding to a respective viewer annotated video fragment, segment or frame of the course video.

15. The method of claim 14, wherein each annotation data record includes the annotation text entered by the viewer and a temporal identification of the video fragment or segment to which the annotation text applies.

16. The method of claim 14 further comprising including a URL link in an accumulated annotation data record, the URL link being a link to the video fragment or segment to which the annotation text applies.

17. The method of claim 16 further comprising:
when a user query or search term has a match in the annotation text in the accumulated annotation data record, returning information in the accumulated annotation data record as a search result, the returned information including the link to the specific video fragment of course video to which the annotation text applies.

18. The method of claim 11 further comprising making the database accessible to external query or search engines.

19. A non-transitory computer readable medium, comprising instructions capable of being executed on a microprocessor, which instructions when executed allow a computer device to:
display an on-line education course video to one or more viewers;
receive viewer annotations data including viewer annotations of video fragments, segments or frames of the displayed course video; and
accumulate the viewer annotations data in a database.

20. The non-transitory computer readable medium of claim 19, wherein the instructions when executed on the microprocessor cause the computer device to provide an annotation tool on viewing devices that the one or more viewers can use to annotate fragments, segments of frames of the displayed course video.

21. The non-transitory computer readable medium of claim 19, wherein the viewer annotations data includes annotation text and time identification of the video fragment, segment or frame to which the annotation text applies.

22. The non-transitory computer readable medium of claim 19, wherein the instructions when executed on the microprocessor cause the computer device to accumulate the viewer annotations data as annotation data records, each data record corresponding to a respective viewer annotated video fragment, segment or frame of the course video.

23. The non-transitory computer readable medium of claim 22, wherein each annotation data record includes the annotation text entered by the viewer and a temporal identification of the video fragment or segment to which the annotation text applies.

24. The non-transitory computer readable medium of claim 22, wherein the instructions when executed on the microprocessor cause the computer device to include a URL link in an accumulated annotation data record, the URL link being a link to the video fragment or segment to which the annotation text applies.
